(19) United States
(12) Patent Application Publication
(10) Pub. No.: US 2015/0232365 A1
(43) Pub. Date: Aug. 20, 2015

(54) APPARATUS AND METHODS OF MAKING A GLASS TUBE BY DRAWING FROM MOLTEN GLASS

(71) Applicant: Corning Incorporated, Corning, NY (US)

(72) Inventors: Antoine Gaston Denis Bisson, Corning, NY (US); Patrick Joseph Cimo, Corning, NY (US); Thierry Luc Alain Dannoux, Avon (FR); Allan Mark Fredholm, Vulaines sur Seine (FR)

(21) Appl. No.: 14/422,579

(22) PCT Filed: Aug. 29, 2013
(86) PCT No.: PCT/US2013/057180

§ 371 Date: Feb. 19, 2015

Related U.S. Application Data
(60) Provisional application No. 61/694,923, filed on Aug. 30, 2012.

(51) Int. Cl. C03B 17/04; C03B 23/047; C03B 40/04

(52) U.S. Cl. CPC C03B 17/04; C03B 40/04; C03B 23/047

(57) ABSTRACT

A glass tube making apparatus comprises a forming device with a shaping member positioned within a downstream portion of an outer tube. In further examples, methods of making a glass tube include the steps of passing a quantity molten glass through an upstream portion of the outer tube, wherein the molten glass includes a first cross-sectional shape. The method further includes the step of passing the quantity of molten glass through a downstream portion of the outer tube, wherein the first cross-sectional shape is transitioned to a second cross-sectional shape. In still further examples, methods of making a glass tube include the step of modifying a cross-sectional shape of the glass tube with an air bearing.

### CROSS-REFERENCE TO RELATED APPLICATIONS

This application claims the benefit of priority under 35 U.S.C. §119 of U.S. Provisional Application Ser. No. 61/694,923 filed on Aug. 30, 2012, the content of which is relied upon and incorporated herein by reference in its entirety.

### TECHNICAL FIELD

The present invention relates generally to apparatus and methods of making a glass tube and, more particularly, to glass tube making apparatus with a forming device including an outer tube and a shaping member, methods of making a glass tube with the forming device, and methods of making a glass tube including the steps of modifying a cross-sectional shape of the glass tube with an air bearing.

### BACKGROUND

Conventional methods and apparatus are known to provide glass tubes. For example, glass tubes are known to be formed during an extrusion process, downwardly flowing molten glass over a tapered valve, and flowing molten glass over an outer surface of a cylindrical shell. Such conventional techniques can provide continuous manufacture of glass tubes during the manufacturing process.

### SUMMARY

The following presents a simplified summary of the disclosure in order to provide a basic understanding of some example aspects described in the detailed description.

In accordance with a first example aspect, a glass tube making apparatus comprises a forming device comprising an outer tube and a shaping member. The outer tube includes an inner surface defining an interior area configured to provide passage of molten glass. The inner surface includes an upstream portion and a downstream portion, wherein a cross-sectional shape of the upstream portion of inner surface taken perpendicular to an axis of the outer tube is geometrically different than a cross-sectional shape of the downstream portion of the inner surface taken perpendicular to the axis. The shaping member is positioned within the downstream portion of the outer tube. Molten glass is configured to be drawn with a glass tube cross-sectional profile defined by a cross-sectional area between the downstream portion of the inner surface and an outer surface of the shaping member.

In one example of the first aspect, the cross-sectional shape of the upstream portion of the inner surface is substantially circular.

In another example of the first aspect, the cross-sectional shape of the downstream portion of the inner surface is oblong.

In still another example of the first aspect, the shaping member includes a pair of opposed recessed walls extending between opposed end portions of the shaping member.

In yet another example of the first aspect, an outer surface of the shaping member is configured to deliver an air interface between the shaping member and the glass tube being drawn from the forming device.

In still another example of the first aspect, the downstream portion of the inner surface diverges in a downstream direction.

In a further example of the first aspect, the cross-sectional area between the downstream portion of the inner surface and the outer surface of the shaping member is configured to draw the glass tube cross-sectional profile with a wall thickness that varies about a periphery of the glass tube.

Any examples of the first example aspect may be used alone or in combination with any number of the other examples of the first example aspect discussed above.

In accordance with a second example aspect, a method of making a glass tube comprises the step of providing a forming device including an outer tube and a shaping member. The method further includes the step of passing a quantity molten glass through an upstream portion of the outer tube, wherein the molten glass includes a first cross-sectional shape taken along a direction perpendicular to an axis of the outer tube. The method still further includes the step of passing the quantity of molten glass through a downstream portion of the outer tube, wherein the first cross-sectional shape is transitioned to a second cross-sectional shape defined between the inner surface of the downstream portion of the outer tube and an outer surface of the shaping member. The method further includes the step of drawing a molten glass tube from the forming device including a tube wall cross-sectional profile defined by the second cross-sectional shape.

In accordance with one example of the second aspect, the method further comprises the step of providing an air interface between a lower portion of the shaping member and the inner surface of the molten glass tube.

In another example of the second aspect, the outer periphery of the first cross-sectional shape is substantially circular and the outer periphery of the second cross-sectional shape is oblong.

In a further example of the second aspect, the tube wall cross-sectional profile is drawn with a wall thickness that varies about a periphery of the glass tube.

Any examples of the second example aspect may be used alone or in combination with any number of the other examples of the second example aspect discussed above.

In accordance with a third example aspect, a method of making a glass tube comprises the step (I) of drawing a glass tube from a forming device, wherein a glass tube portion is drawn into a viscous zone. The method further includes the step (II) of modifying a cross-sectional shape of the glass tube portion by application of forming forces to an outer surface of the glass tube portion with an air bearing.

In one example of the third aspect, prior to step (II), the method further comprises the steps of passing the glass tube portion into a transition zone downstream from the viscous zone, and reheating the glass tube portion.

In another example of the third aspect, prior to step (II), the method further comprises the steps of: (a) passing the glass tube portion into a transition zone downstream from the viscous zone; (b) inspecting a feature of the glass tube portion within a first inspection zone; (c) modifying a device upstream from the first inspection zone based on the inspected feature obtained during step (b); and (d) reheating the glass tube portion.

In a further example of the third aspect, step (b) is carried out in a hardened zone downstream from the transition zone.

In still a further example of the third aspect, step (c) modifies a drive device to change the rate that the glass tube is drawn from the forming device.

In yet a further example of the third aspect, step (c) comprises the forming device.

In another example of the third aspect, the feature inspected during step (b) comprises a thickness of the glass tube.

In a further example of the third aspect, the feature inspected during step (b) comprises a shape of the glass tube.

In yet a further example of the third aspect, after step (II), the method further comprises the steps of: inspecting a post-modified feature of the portion of the glass tube in a second inspection zone; and modifying an upstream device based on the post-modified feature obtained during the step of inspecting the post-modified feature.

Any examples of the third example aspect may be used alone or in combination with any number of the other examples of the third example aspect discussed above.

### BRIEF DESCRIPTION OF THE DRAWINGS

These and other aspects are better understood when the following detailed description is read with reference to the accompanying drawings, in which:

FIG. 1 is a schematic view of a first portion of a glass tube making apparatus in accordance with aspects of the disclosure;

FIG. 2 is a schematic view of a second portion of the glass tube making apparatus in accordance with aspects of the disclosure;

FIG. 3 is an enlarged portion of the glass tube making apparatus taken at view 3 in FIG. 2 illustrating forming rollers for modifying a cross-sectional shape of the glass tube;

FIG. 4 is a cross section along line 4-4 of the glass tube of FIG. 3 illustrating a cross-sectional shape of the glass tube prior to a step of modifying a cross-sectional shape of the glass tube;

FIG. 5 is a cross section along line 5-5 of the glass tube of FIG. 3 illustrating a cross-sectional shape of the glass tube after a step of modifying the cross-sectional shape of the glass tube;

FIG. 6 is another example cross section along line 5-5 of the glass tube of FIG. 3 illustrating an alternative cross-sectional shape of the glass tube after a step of modifying the cross-sectional shape of the glass tube;

FIG. 7 is a cross sectional view of another device for modifying a cross-sectional shape of the glass tube comprising a forming bearing comprising an air bearing;

FIG. 8 is a cross sectional view of still another device for modifying a cross-sectional shape of the glass tube comprising a forming bearing comprising a contact bearing;

FIG. 9 is a schematic view of an alternative second portion of the glass tube making apparatus in accordance with aspects of the disclosure;

FIG. 10 illustrates an enlarged view of portions of the glass tube making apparatus of FIG. 9;

FIG. 11 is a sectional view of the glass tube along line 11-11 of FIG. 9;

FIG. 12 illustrates perspective view of an example forming device with an example shaping member positioned within an example outer tube;

FIG. 13 is a top view of the forming device of FIG. 12;

FIG. 14 is a bottom view of the forming device of FIG. 12; and

FIG. 15 is a perspective view of an example shaping device of the forming device.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

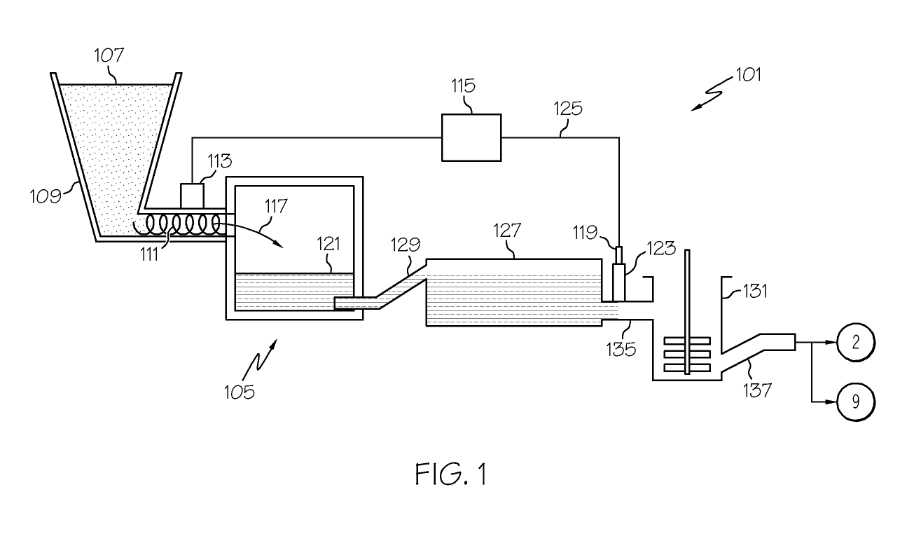

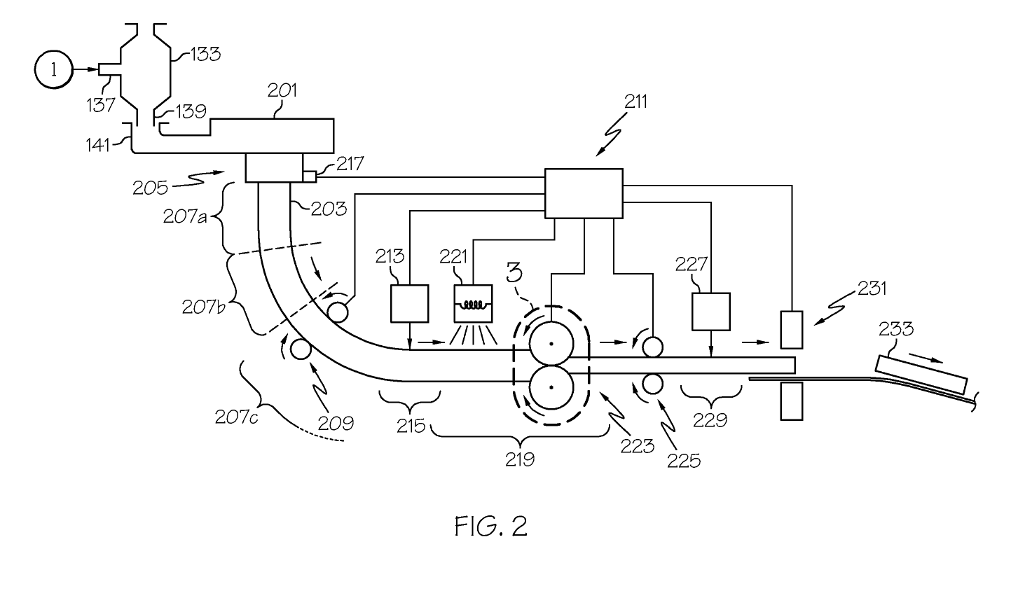

FIGS. 1 and 2 illustrate a schematic view of portions of a glass tube making apparatus 101 for manufacturing a glass tube with a predetermined shape for various applications. FIG. 1 illustrates an upstream portion of the glass tube making apparatus 101 while FIG. 2 illustrates a downstream portion of the glass tube making apparatus 101. As shown in FIG. 1, the glass tube making apparatus 101 can include a melting vessel 105 configured to receive batch material 107 from a storage bin 109. The batch material 107 can be introduced by a batch delivery device 111 powered by a motor 113. An optional controller 115 can be configured to activate the motor 113 to introduce a desired amount of batch material 107 into the melting vessel 105, as indicated by arrow 117. In one example, a glass metal probe 119 can be used to measure a molten glass 121 level within a standpipe 123 and communicate the measured information to the controller 115 by way of a communication line 125.

The glass tube making apparatus 101 can also include a fining vessel 127, such as a fining tube, located downstream from the melting vessel 105 and coupled to the melting vessel 105 by way of a first connecting tube 129. A mixing vessel 131, such as a stir chamber, can also be located downstream from the fining vessel 127. As illustrated in FIG. 2, a delivery vessel 133, such as a bowl, may be located downstream from the mixing vessel 131. As shown, a second connecting tube 135 can couple the fining vessel 127 to the mixing vessel 131 and a third connecting tube 137 can couple the mixing vessel 131 to the delivery vessel 133. As further illustrated, a downcomer 139 can be positioned to deliver molten glass 121 from the delivery vessel 133 to an inlet 141 of a trough 201. As shown, the melting vessel 105, fining vessel 127, the mixing vessel 131, delivery vessel 133, and trough 201 are examples of molten glass stations that may be located in series along the glass tube making apparatus 101.

FIG. 2 illustrates example steps in various possible methods of making a glass tube such as an elongated glass tube 203 that can be continuously drawn from a forming device 205. FIG. 2 is schematic in nature and the curvatures and relative size of the glass tube is exaggerated for clarity. The method can begin by drawing molten glass as a glass tube 203 from the forming device 205 into a viscous zone 207a where the glass tube 203 may be easily deformable. Heating and/or cooling elements may be provided to help achieve desired tube profile shapes and thicknesses of the glass tube wall.

A portion of the glass tube 203 within the viscous zone 207a is then drawn to pass into a transition zone 207b downstream from the viscous zone 207a. In the transition zone 207b, the glass tube begins to harden into a frozen glass tube. The portion of the glass tube 203 is then drawn to pass into a hardened zone 207c downstream from the transition zone 207b.

In one example, a drive device 209 can be used to help draw the glass tube 203 at a predetermined rate from the forming device 205. Drawing the glass tube 203 at different rates can change features of the glass tube. For example, increasing or decreasing the rate that the glass tube 203 is drawn from the forming device 205 may act to change the outer shape and/or size of the glass tube 203. In further examples, changing the draw rate of the glass tube 203 from the forming device 205 can increase or decrease the thickness of the walls of the glass tube 203.

In some examples, the drive device 209 can include at least one roller. For example, as shown, the drive device 209 can include a pair of opposed rollers configured to be driven together, for example, by commands from a controller 211 that may be configured, such as programmed, to operate the drive device 209 to draw the glass tube 203 from the forming device 205 at the proper rate. The drive device 209 is illustrated as contacting the glass tube 203 within the hardened zone 207c although the drive device 209 may engage the glass tube 203 in the transition zone 207b in further examples.

The portion of the glass tube 203 may then be drawn into a first inspection zone 215 where an inspection device 213 may be used to help determine a feature of the portion of the glass tube 203. For example, the inspection device 213 may be used to help determine a thickness of the glass tube 203. In another example, the inspection device 213 may be used to help determine a shape and/or size of the glass tube although other features of the glass tube 203 may be monitored in further examples.

The method of making the glass tube can also include the step of modifying a device upstream from the first inspection zone 215 based on the inspected feature (e.g., tube shape, size, wall thickness, etc.) obtained from the inspection device 213. The controller can receive information from the inspection device 213 and then operate to modify a device upstream from the first inspection zone 215 based on the inspected feature.

On one example, the upstream device may comprise the drive device 209. For instance, in one example, the controller may modify the drive device 209 to change the rate that the glass tube 203 is drawn from the forming device 205. For example, the inspection device 213 may determine that the glass tube includes an inspected thickness “T1”. The controller 211 may compare the inspected thickness “T1” to a desired thickness “T”. If the inspected thickness “T1” is greater than the desired thickness “T”, the controller 211 may modify the drive device 209 to increase the rate that the glass tube 203 is drawn from the forming device 205 to help reduce the thickness of “T1” to more closely approximate the desired thickness “T”. Likewise, if the inspection thickness “T1” is less than the desired thickness “T”, the controller 211 may modify the drive device 209 to reduce the rate that the glass tube 203 is drawn from the forming device 205 to help increase the thickness “T1” to more closely approximate the desired thickness “T”.

In another example, the upstream device may comprise the forming device 205. The controller may modify the forming device 205 to help provide a desired thickness profile (e.g., substantially constant thickness or other thickness profile) about the periphery of the glass tube. For instance, the controller 211 may send a signal to an actuator 217 configured to tilt an angle between the forming device 205 and the trough 201 to change the thickness profile of the glass tube about the periphery of the tube. As such, appropriate tilting can help compensate for thickness variations that are outside of the desired range.

In still another example, a heating and/or cooling device maybe positioned to selectively heat and/or cool the glass tube at preselected positions about the periphery of the glass tube within the viscous zone 207a and/or the vicinity where the molten glass is being drawn into the glass tube. As such, molten glass flow can be modified to change the molten glass flow characteristics of the molten glass forming different portions of the glass tube. In such examples, controlling the temperature at preselected locations can likewise facilitate in obtaining a glass tube with the desired thickness profile about the periphery of the glass tube.

The portion of the glass tube 203 can then pass into a modifying zone 219 downstream from the first inspection zone 215. The modifying zone can modify the cross-sectional shape of the glass tube to accommodate various applications. The portion of the glass tube can be heated in the modifying zone 219 by a heating device 221. Various heating devices may be provided such as a resistance heating device, burners or other heat sources to bring the portion of the glass tube to a forming temperature. In some examples, the glass tube may still be within the transition zone 207b when entering the modifying zone 219 to be reheated to the appropriate temperature for forming the glass tube 203.

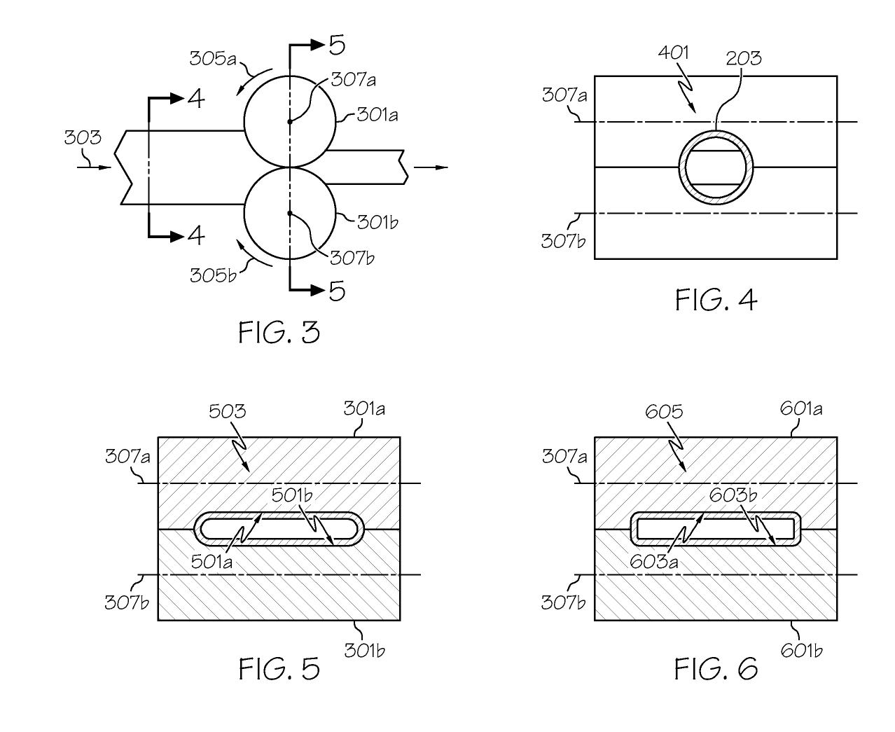

As shown schematically in FIG. 2, after reheating, the cross-sectional shape of the glass tube 203 may be modified by a modification device 223 configured to apply forming forces to an outer surface of the glass tube 203. For instance, as shown in FIG. 3, the forming device can comprise a pair of opposed forming rollers 301a, 301b. As shown in FIG. 5, each of the forming rollers 301, 301b can include a pair of corresponding forming surfaces 501a, 501b. As shown in FIG. 4, in one example, the portion of the glass tube 203 may include a substantially circular profile 401 that may have been initially generated when drawing the glass tube 203 from the forming device 205. The portion of the glass tube travels along direction 303 while the forming rollers 301a, 301b rotate along respective directions 305a, 305b about respective rotation axes 307a, 307b. The illustrated forming rollers 301a, 301b comprise idle rollers although the rollers may be driven in further examples. As further illustrated, the glass tube can then achieve an oblong cross-sectional shape such as the illustrated oval cross-sectional shape 503 that follows the forming surfaces 501a, 501b of the forming rollers 301a, 301b. FIG. 6 illustrates another example of forming rollers 601a, 601b similar to the forming rollers 301a, 301b but including alternative forming surfaces 603a, 603b configured to modify a cross-sectional shape of the glass tube to achieve another oblong cross-sectional shape such as the illustrated rectangular cross-sectional shape 605.

FIGS. 5 and 6 illustrate just two example oblong cross-sectional shapes of a wide range of cross-sectional shapes (e.g., egg-shaped or otherwise) that may be provided in accordance with examples of the disclosure. Furthermore, the modified cross-sectional shape may be another circular shape with a different configuration. As shown in FIG. 6, rectangular shapes may be provided while other polygonal shapes may be achieved with three or more sides in further examples. In each of the examples, an interior of the tube may be placed under pressure to help appropriately shape the glass tube.

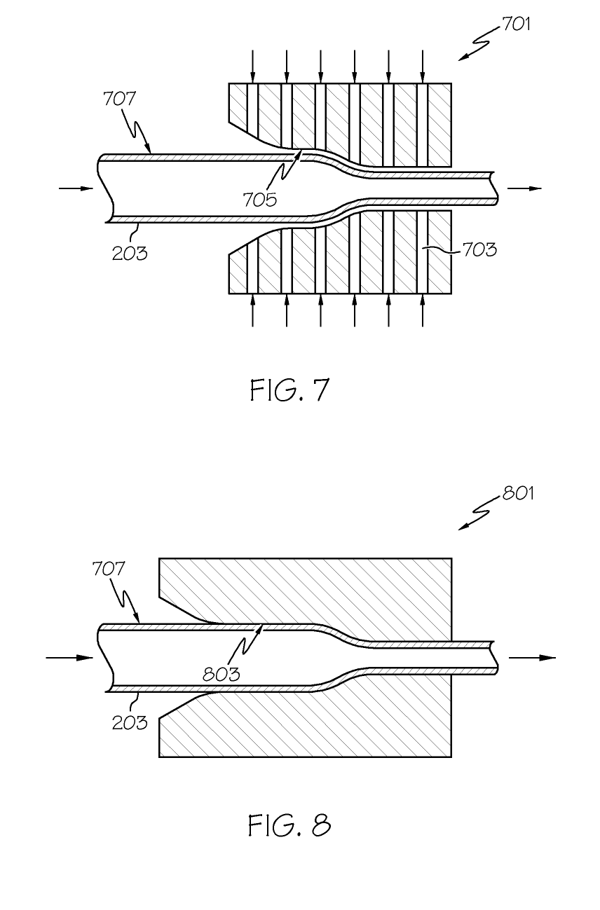

Modification devices other than forming rollers may be provided to apply the appropriate forming forces to the outer surface of the glass tube. For example, a forming bearing may be used to shape the glass tube as it is passed through an interior forming channel of the forming bearing. FIG. 7 illustrates the forming bearing comprising an air bearing 701 including a plurality of pressure ports 703 configured to maintain a desired space between a forming surface 705 and an outer surface 707 of the glass tube 203. As such, the cross-sectional shape of the glass tube 203 may be modified by the forming surface 705 with minimal, if any, engagement with the outer surface 707 of the glass tube 203. As such, surface quality of the outer tube can be maintained in optimal condition.

FIG. 8 illustrates yet another forming bearing comprising a contact bearing 801 including a forming surface 803 configured to contact the outer surface 707 of the glass tube 203 to apply the appropriate forming forces. A contact bearing 801 may be provided with a low friction material to minimize scratching of the outer surface 707. The contact bearing 801 may be less expensive than an air bearing while still providing an adequate level of outer surface quality in various applications.

As further illustrated in FIG. 2, the apparatus may include an optional second drive device 225 that may help draw the glass tube from the modification device 223. For example, increasing the rotation rate of the drive device 225 can reduce the thickness of the glass tubes if the modification device 223 restricts movement of the glass tube while modifying the cross-sectional shape of the glass tube.

As further illustrated in FIG. 2, an optional second inspection device 227, similar to the inspection device 213 may be provided to likewise measure a post-modified feature of the portion of the glass tube in a second inspection zone 229. Feedback regarding the measured feature can then be sent back to the controller 211 to modify an upstream device based on the post-modified feature obtained by the second inspection device 227. As such, further fine tuning of the final shape of the glass tube may be provided by way of the second inspection device 227. For example, the second inspection device 227 may determine that the thickness of the glass tube 203 is too thick, wherein the controller would signal the drive device 225 to rotate faster to increase the rate that the glass tube is drawn from the modifying device 223. Alternatively, the second inspection device 227 may determine that the thickness of the glass tube 203 is too thin, wherein the controller would signal the drive device 225 to rotate slower to reduce the rate that the glass tube is drawn from the modifying device 223. Still further, the second inspection device 227 may determine that the overall shape of the glass tube is too large. In the example, of FIG. 7, the controller 211 may increase the pressure provided to the pressure ports 703, thereby further reducing the cross-sectional size of the glass tubes. Alternatively, if the overall shape of the glass tube is too small, the pressure applied by the pressure ports 703 may be reduced based on command signals from the controller 211.

A cutting mechanism 231 may then cut a glass tube segment 233 of desired length from the continuous glass tube draw. As such, molten glass can be continuously drawn into an elongated glass tube that is periodically cut into glass tube segments.

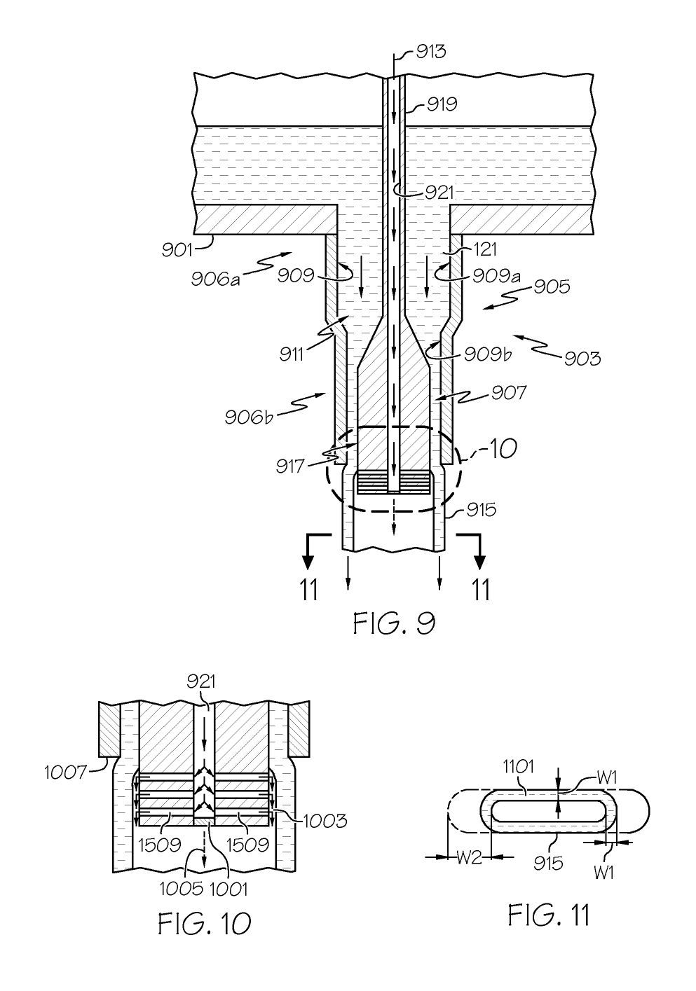

FIG. 9 illustrates another example forming device in accordance with further examples of the disclosure. FIG. 9 can be considered an alternative continuation of FIG. 1 wherein the delivery device 133, downcomer 139 and inlet 141 to the trough 901 are not shown for clarity. As further shown, the glass tube making apparatus further includes a forming device 903 that may be integrated at the bottom of the illustrated trough 901 although the forming device 903 may be provided at the end of an extrusion device in further examples. The forming device 903 comprises an outer tube 905 and a shaping member 907 that may be separate parts (as shown) although the outer tube and shaping member may be integrated as a single part in further examples. The outer tube 905 includes an inner surface 909 defining an interior area 911 configured to provide passage of molten glass 121. The outer tube 905 includes an upstream portion 906a and a downstream portion 906b. The inner surface 909 includes an upstream portion 909a associated with the upstream portion 906a of the outer tube 905. The inner surface 909 further includes a downstream portion 909b associated with the downstream portion 906b of the outer tube 905.

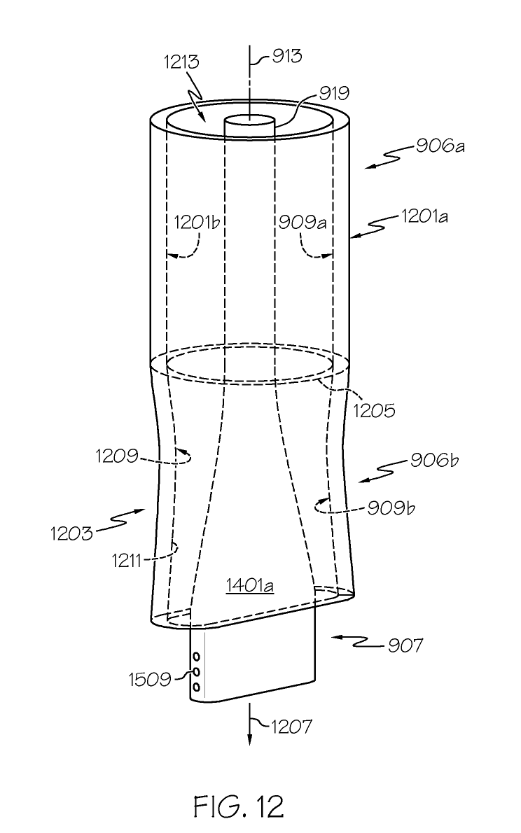

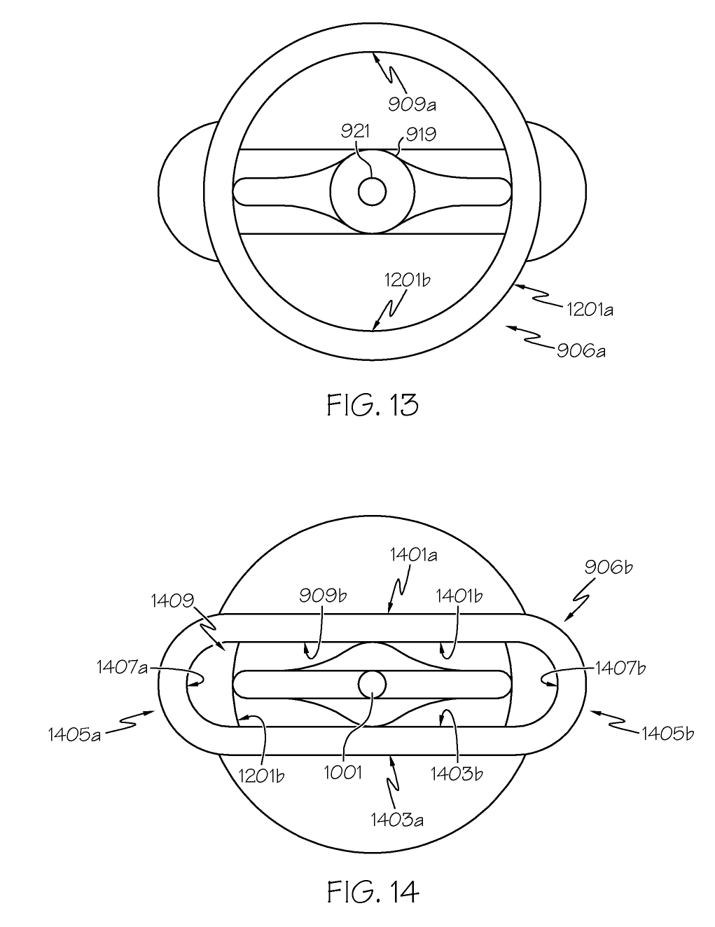

A cross-sectional shape of the upstream portion 909a of inner surface 909 taken perpendicular to an axis 913 of the outer tube 905 is geometrically different than a cross-sectional shape of the downstream portion 909b of the inner surface 909 taken perpendicular to the axis 913. In one example, as shown in FIGS. 12 and 13, the cross-sectional shape of the upstream portion 909a of the inner surface 909 is substantially circular. In addition or alternatively, as shown in FIGS. 12 and 14, the cross-sectional shape of the downstream portion 909b of the inner surface is oblong.

Example features of the outer tube 905 will now be described with reference to FIGS. 12-14. The outer tube 905 can comprise a tubular structure constructed with substantially the same wall thickness throughout the upstream and downstream portions 906a, 906b of the outer tube 905. The inner surface portions therefore follow the corresponding outer surface portions of the outer tube 905. As such, inner surface features of the outer tube 905 can be understood based on review of the outer surface features.

As shown in FIG. 12, the upstream portion 906a can include an outer circular cylindrical surface 1201a that follows in inner circular cylindrical surface 1201b. Referring to FIG. 14, the downstream portion 906b can include a first outer flat surface 1401a that follows a first inner flat surface 1401b. Likewise the downstream portion 906b can also include a second outer flat surface 1403a that follows a second inner flat surface 1403b. The downstream portion 906b can also include a first rounded end portion 1405a and a second rounded end portion 1405b defining respective inner surfaces 1407a, 1407b.

Referring back to FIG. 12, the outer tube 905 can also include a transition region 1203 that begins at imaginary ring 1205 and has an inner surface 1209 that tapers inwardly in a downstream direction 1207. The transition region can also include another inner surface 1211, downstream from the inner surface 1209 that tapers outwardly in the downstream direction 1207.

As further shown in FIG. 9, the shaping member is positioned within the downstream portion 906b of the outer tube 903, wherein molten glass is configured to be drawn as a glass tube 915 with a glass tube cross-sectional profile 1101 (see FIG. 11) defined between the downstream portion 909b of the inner surface 909 and an outer surface 917 of the shaping member 907.

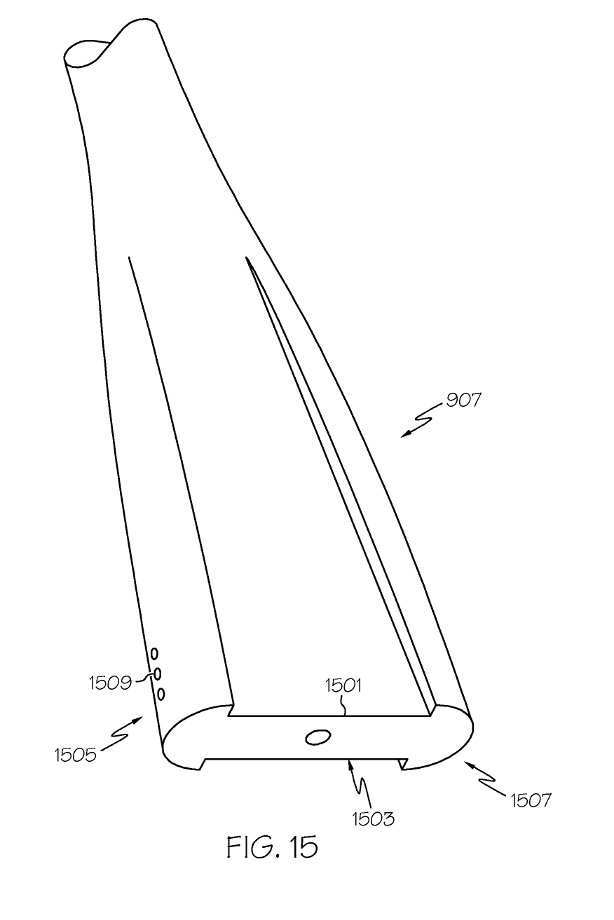

Aspects of the shaping member 907 will now be described with reference to FIG. 15. As shown, the shaping member 907 can include a pair of opposed recessed walls 1501, 1503 extending between opposed end portions 1505, 1507 of the shaping member. As shown, the end portions 1505, 1507 may comprise bulbous end portions. In one example, the outer surface of the shaping member is configured to deliver an air interface between the shaping member and the glass tube being drawn from the forming device. For example, as shown in FIG. 15, the outer surface of the end portions 1505, 1507 may include a plurality of air ports 1509 configured to deliver air pressure to the surface of the end portions 1505, 1507.

Methods of making a glass tube will not be described with respect to FIGS. 9 and 10. The method includes passing a quantity molten glass 121 through an upstream portion 906a of the outer tube 905, wherein the molten glass includes a first cross-sectional shape taken along a direction perpendicular to an axis of the outer tube. Indeed, as illustrated in FIG. 12, the first cross sectional shape comprises a ring cross section 1213.

The method also includes the step of passing the quantity of molten glass through the downstream portion 906b of the outer tube 905. The first cross-sectional shape 1213 is transitioned to a second cross-sectional shape 1409 (see FIG. 14) defined between the inner surface 909b of the downstream portion 906b of the outer tube 905 and the outer surface 917 of the shaping member 907.

The method also includes the step of drawing the molten glass from the forming device including a tube wall cross-sectional profile 1101 (see FIG. 11) defined by the second cross-sectional shape 1409. Various profiles of various shapes, sizes and thicknesses can be provided. For example, FIG. 11 illustrates the cross-sectional shape 1409 as oblong with the understanding that various other shapes may be provided in further examples. Moreover, the wall thicknesses may be controlled to provide a desired wall thickness profile that varies about a periphery of the glass tube. For instance, any of the apparatus and methods of the present disclosure may provide a substantially constant wall thickness W1 about the periphery of the glass tube. Alternatively, as shown in broken lines, various portions about the periphery of the glass tube may have alternate thicknesses. For instance, the ends of the oblong tube may include a larger thickness W2 than the mid-section of the oblong tube.

In one example, an air interface can be provided between a lower portion of the shaping member and the inner surface of the molten glass tube. For example, as shown in FIG. 9, the shaping member 907 may be supported by a support shaft 919 that may include a hollow air bore 921 that can be plugged at end 1001 shown in FIG. 10. As such, pressurized air can be forced down through the hollow air bore 921 to the air ports 1509 to create the air interface 1003 shown in FIG. 10. The support shaft 919 can support the shaping member 907 in the illustrated position. An adjustment mechanism (not shown) may also be provided to allow the support shaft 919 to be adjusted in any direction relative to the outer tube 905. In one example, the support mechanism may be configured to adjust along an axis including the downstream direction 1207. The taper of the outer tube and/or the taper of the shaping member 907 can adjust the glass flow rate by adjusting the cross-sectional area (which directly impacts the head loss of the system).

Providing the air ports 1509 can help create an air interface as the end portions 1505, 1507 of the shaping member 907 to help release the glass tube 915 from the shaping member. As shown in FIGS. 9 and 10, the end of the shaping member 907 including the air ports 1509 can extend downstream from a lower edge 1007 of the outer tube 905. As such, once the glass tube is drawn from the lower edge 1007 of the outer tube 905, the air ports 1509 and recessed walls 1501, 1503 can help release the glass tube from the shaping member. In some examples, the walls may be recessed from about 150 microns to about 1000 microns although other recessed configurations may be provided in further examples. Furthermore, the air ports may be pressurized to the extent that the shape of the glass tube may be slightly modified to achieve desired shape characteristics and/or thicknesses in the walls of the glass tube. As shown in FIG. 10, optionally, the air bore 921 or another air bore may be designed to provide pressurized air 1005 the help create a predetermined over pressure within the glass tube, such as from about 5 mbar to about 30 mbar.

In further examples, heating and or cooling may be added, for example, to the shaping member 907 to provide thermal control of the glass tube 915. For instance, a temperature control manifold may extend below the forming device and include an array of heating and/or cooling elements configured to be controlled together or independently to selectively control targeted areas of the glass tube. Temperature control can help adjust glass thickness and/or otherwise provide enhanced glass tube formation as the tube is formed off the shaping member 907. In one example, temperature can help control the viscosity of the molten glass forming the tube off the shaping member. For instance, the temperature control or other process parameters can provide the glass tube flowing off the end of the shaping member 907 with a viscosity of from about 10 Poise to about 100 Poise.

Aspects of the disclosure can provide various tubular configurations having a consistent or varying thickness as desired. As such tubular configurations of potentially limitless shapes may be provided. Moreover, a variable wall thickness may be provided or a constant wall thickness may be provided depending on the particular application requirements. The tube forming apparatus and techniques described herein provide good surface quality with a low level of inclusions and/or streaks, high glass clarity and high throughput.

The forming member 903, such as the outer tube 905 and the shaping member 907, may be formed from a wide range of materials such as platinum and platinum based alloys. Silicon carbide or graphite (requiring a controlled atmosphere in the surrounding environment), depending on the glass considered, can be used.

It will be apparent to those skilled in the art that various modifications and variations can be made without departing from the spirit and scope of the claimed invention.

What is claimed is:

1. A glass tube making apparatus comprising:
a forming device comprising an outer tube and a shaping member,
the outer tube including an inner surface defining an interior area configured to provide passage of molten glass, wherein the inner surface includes an upstream portion and a downstream portion, wherein a cross-sectional shape of the upstream portion of inner surface taken perpendicular to an axis of the outer tube is geometrically different than a cross-sectional shape of the downstream portion of the inner surface taken perpendicular to the axis, and
the shaping member is positioned within the downstream portion of the outer tube, wherein molten glass is configured to be drawn with a glass tube cross-sectional profile defined by a cross-sectional area between the downstream portion of the inner surface and an outer surface of the shaping member.

2. The apparatus of claim 1, wherein the cross-sectional shape of the upstream portion of the inner surface is substantially circular.

3. The apparatus of claim 1, wherein the cross-sectional shape of the downstream portion of the inner surface is oblong.

4. The apparatus of claim 1, wherein the shaping member includes a pair of opposed recessed walls extending between opposed end portions of the shaping member.

5. The apparatus of claim 1, wherein an outer surface of the shaping member is configured to deliver an air interface between the shaping member and the glass tube being drawn from the forming device.

6. The apparatus of claim 1, wherein the downstream portion of the inner surface diverges in a downstream direction.

7. The apparatus of claim 1, wherein the cross-sectional area between the downstream portion of the inner surface and the outer surface of the shaping member is configured to draw the glass tube cross-sectional profile with a wall thickness that varies about a periphery of the glass tube.

8. A method of making a glass tube comprising the steps of:
providing a forming device including an outer tube and a shaping member;
passing a quantity molten glass through an upstream portion of the outer tube, wherein the molten glass includes a first cross-sectional shape taken along a direction perpendicular to an axis of the outer tube;
passing the quantity of molten glass through a downstream portion of the outer tube, wherein the first cross-sectional shape is transitioned to a second cross-sectional shape defined between the inner surface of the downstream portion of the outer tube and an outer surface of the shaping member; and
drawing a molten glass tube from the forming device including a tube wall cross-sectional profile defined by the second cross-sectional shape.

9. The method of claim 8, further comprising the step of providing an air interface between a lower portion of the shaping member and the inner surface of the molten glass tube.

10. The method of claim 8, wherein the outer periphery of the first cross-sectional shape is substantially circular and the outer periphery of the second cross-sectional shape is oblong.

11. The method of claim 8, wherein the tube wall cross-sectional profile is drawn with a wall thickness that varies about a periphery of the glass tube.

12. A method of making a glass tube comprising the steps of:
(I) drawing a glass tube from a forming device, wherein a glass tube portion is drawn into a viscous zone; and
(II) modifying a cross-sectional shape of the glass tube portion by application of forming forces to an outer surface of the glass tube portion with an air bearing.

13. The method of claim 12, wherein prior to step (II), further comprising the steps of passing the glass tube portion into a transition zone downstream from the viscous zone, and reheating the glass tube portion.

14. The method of claim 12, wherein, prior to step (II), further comprising the steps of:
(a) passing the glass tube portion into a transition zone downstream from the viscous zone;
(b) inspecting a feature of the glass tube portion within a first inspection zone;
(c) modifying a device upstream from the first inspection zone based on the inspected feature obtained during step (b); and
(d) reheating the glass tube portion.

15. The method of claim 14, wherein step (b) is carried out in a hardened zone downstream from the transition zone.

16. The method of claim 14, wherein step (c) modifies a drive device to change the rate that the glass tube is drawn from the forming device.

17. The method of claim 14, wherein the upstream device of step (c) comprises the forming device.

18. The method of claim 14, wherein the feature inspected during step (b) comprises a thickness of the glass tube.

19. The method of claim 14, wherein the feature inspected during step (b) comprises a shape of the glass tube.

20. The method of claim 12, wherein, after step (II), further comprising steps of:
inspecting a post-modified feature of the portion of the glass tube in a second inspection zone; and
modifying an upstream device based on the post-modified feature obtained during the step of inspecting the post-modified feature.
